(19) United States
(12) Patent Application Publication
(10) Pub. No.: US 2003/0055909 A1
(43) Pub. Date: Mar. 20, 2003

(54) Pluggable server module for wireless remote controlling of devices

(76) Inventors: Stephan Hartwig, Essen (DE); Lauri Piikivi, Oulu (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/935,545

(22) Filed: Aug. 24, 2001

(51) Int. Cl. G06F 15/16

(52) U.S. Cl. 709/208

(57) ABSTRACT

A pluggable server module (PSM) (10) for remote controlling of a device (11) is provided. The PSM (10) comprises a wireless transceiver (1), a server remote control logic (4) and a standardized interface and connector (5). The wireless transceiver (1) is connected to the computing means (2, 3). The computing means (2, 3) is connected to the server remote control logic (4), and the server remote control logic (4) is connected to the standardized interface and the connector (5). In use the PSM (10) is plugged into a device (11) to be controlled via a standard interface and connector (5).

The invention addresses the field of embedded servers that are used for remote control purposes. In particular, the invention relates to a pluggable server module for connecting to a device to be controlled and methods for operating such server modules as well as methods for preparing such server modules with supplying appropriate user interfaces and other auxiliary contents to said server modules like user manuals, service contacts, etc.

The concept of embedded HTTP and WAP servers for remote control purposes has been widely published. The idea is to equip devices like window blinds or Video Cassette Recorders (VCRs) with embedded servers (e.g. WAP or HTTP) and then use a standard hypertext browser terminal (e.g. a WAP enabled mobile phone) to control these devices. This is possible, because web servers implement an execution environment in which certain actions e.g. can be triggered upon HTTP or WAP requests and the content pages are created dynamically. One well known execution environment is the so-called Common Gateway Interface (CGI).

Device manufacturers may face several problems when integrating embedded servers into their product, e.g. high costs, missing experience for embedded servers and difficult updates of the embedded servers.

It is one object of the present invention to offer a remote control server option to devices by avoiding that the devices get more expensive when this option is not selected.

Another object of the present invention is to enable manufacturers to offer a remote control server option to their devices.

Yet another object of the present invention is to provide simple and easy contents/software update method for a remote control server.

According to a first aspect of the present invention a pluggable server module (PSM) for remote controlling of a device is provided. The PSM comprises a wireless transceiver, like infrared or low power radio transceiver like bluetooth, WLAN, homeRF etc., a computing means, a server remote control logic and a standardized interface and connector. The wireless transceiver is connected to the computing means. The computing means is connected to the server remote control logic, and the server remote control logic is connected to the standardized interface and the connector. The PSM may even comprise an internal power source, to prevent the loss of data even in the case of a general power breakdown or a change of the device to be remote controlled. Standardized in this respect means that the interface works in accordance with a globally or regionally accepted standard or even according to a manufacturer specific standard.

This invention addresses especially the usage of a low power radio link as a means to connect a terminal (e.g. a mobile phone or personal digital agent (PDA)) to an HTTP or WAP server. It is proposed not to integrate the server into the device, but to create a general purpose, PSM which can be retrofitted into any device prepared for this. This PSM can be produced by any manufacturer and it would fit into any device which implements the correct connector and interfaces. The device specific user interface could be made available by the device manufacturer (e.g. over internet) and uploaded into the module, either by the end-user or the dealer. The device specific user interface (DSUI) could be a program or a file, enabling the PSM to transform e.g. voltage states in the interface and the connector to a display contents readable by humans. The DSUI should not be implemented directly in the PSM, because the PSM is a general purpose device and should be able to be plugged in every device equipped with an Interface and a connector. The device can be any device in the proximity of the user, like devices in the bureau, in the car or public transportation means, in the household. It is even devisable to control devices connected to a bus system like, e.g., the European installation bus (EIB) or the like.

Preferably, the pluggable server module (PSM) further comprises a hypertext content server being connected to the low power radio transceiver via a protocol stack. This protocol stack could be the Wireless Application Protocol (WAP) Stack HTTP/TCP/IP stack, or any other protocol being user for hypertext transfer. The content server hosts hypertext content like WML, WML script, HTML, XHTML or XML. The server is connected to or executed by the computing means. The WAP server enables the PSM to use standardized transmission protocols, so no new transmission protocols have to be developed.

Advantageously the pluggable server module (PSM) further comprises storage means connected to the computing means. This storage means is applied for

storing hypertext content constituting the user interface and auxiliary information

storing executable content like server side scripts

storing any data produced by server side script or passed by the connected device through the DSUI

The storage means enables the general purpose pluggable server, e.g. to store the device specific user interfaces (DSUI) of different devices, so that the PSM will not require any content/software updates, if used on a limited number of devices sequentially.

According to another aspect of the present invention, a device comprising a device logic element is provided, which additionally comprises a device control logic and a standardized interface and connector. The standardized interface and connector are connected to the device control logic. The device control logic is connected to said device logic element, to convert the signals received from said interface and connector to commands executable by the device logic. The device may vary and so may the commands executed by the device. The device may be an autonomous lawn mower, a washing machine, lights, or even a connector for an installation bus.

Preferably, the device further comprises storage means for storing, e.g., device specific user interface (DSUI) data. This would enable the PSM to offer a ‘plug and play’ option, wherein the PSM can access the data directly when inserted in the device, without requiring special update or DSUI access methods.

According to another aspect of the present invention a wireless remote control terminal (WRCT) for remote controlling a device with an inserted PSM comprises a low power radio transceiver, displaying means, and input means. Preferably the low power radio transceiver used in the PSM or in the WRCT is a Bluetooth™ module, a media like home radio frequency (RF), wireless local area networks (LAN), or the like. Advantageously the WRCT is incorporated in a terminal device of a communication network, like a WAP enabled mobile telephone.

According to just another aspect of the invention a method for remote controlling of a device by a wireless remote control terminal via a wireless link and a pluggable server module (PSM) is provided. The PSM is connected via a standardized interface and connector to the device to be remotely controlled. The method comprises the steps of: first transferring a contents request by a wireless protocol stack like WAP via wireless link from the wireless remote control terminal to the PSM; The content request is used to parameterize and trigger the desired remote command to be executed in the device to be controlled. The execution of the remote command is invoked by means of a protocol running on the interface between the pluggable server and the device under control. The result of the execution may be communicated from said device to the PSM, and may be used to parameterize the creation of the corresponding response page to be transmitted and displayed on the remote control terminal. The response page can not only be a user interface (UI), but also contain user manual, advertisement, whatsoever.

Preferably the method further comprises the steps of: transferring content by a communication protocol from said PSM to said wireless remote control terminal (WRCT), also containing commands for controlling the device or the PSM via said wireless link; displaying the transferred commands on a display in the WRCT; selecting one of the commands in said terminal, by a user input; and generating a contents request according to said selection. One other part of the invention is to predefine URLs in the pluggable server that trigger certain actions on the servers interface, e.g. there could be an URL://connector_pin1_UP would mean to put pin1 on the interface to high. The advantage of this would be that without supporting the upload of server side scripts, actions on the interface could be triggered by plain WML and WML-script. This is important, because native scripts would require compilation for the servers microprocessors and server-side script interpreters (like java) are expensive to be implemented.

According to another aspect of the present invention a method for preparing the server is provided by transferring user interface data for remote controlling of a device by means of a pluggable server module (PSM), from said device to said PSM. The method comprises the steps of first detecting a PSM connected to a standardized interface and connector (SIAD) plugged in a device with a SIAD; secondly retrieving said user interface data from storage means in the device; and then transferring said user interface data to the PSM via the SIAD. This method can be applied in the case that the PSM can access device specific user interface (DSUI) data stored in the device via the SIAD. This requires additional contacts and a storage means in the device. The benefits are that this method offers a ‘plug and play’ option to the PSM, so that the user won't need to search for software in the internet, the WEB and so on. The major drawback is that faulty software is more difficult to replace.

According to another aspect of the present invention there is provided a preparation method for pre-loading said user interface content into the pluggable server module. The method comprises the steps of first requesting device identifying information from the device, containing at least device and manufacturer related information. Secondly, the device identifying information are received and stored in the PSM. Thirdly the device identifying information is transferred to a Network Access point in proximity. This could be said remote control device if it could connect e.g. to a cellular network. Fourthly, the device identifying information is transferred to a manufacturer server over the network access point. Fifthly, the interface information according to the device identifying information is transmitted to the PSM via the network access point. Sixthly, the user interface information is stored in the PSM.

Preferably, the transfer of said device identifying information from said remote control device to a manufacturer server, is executed by: transferring the device identifying information first to an internet access point via a communication network, and then transferring said device identifying information from said internet access point to said manufacturer server via Internet.

According to yet an additional aspect of the present invention, a computer program for remote controlling a device by means of a wireless transmission link is provided. The computer program, comprises program code means for carrying out the steps of anyone of the aforementioned methods, when said program is run on a PSM or a user interface device.

Because the PSM and the user interface device are distributed, the computer program comprises a distributed structure, too. Therefore, for the execution of the aforementioned method, the computer program contains at least two different parts: one running on the PSM and the other running on the interface device. The scope of the computer program claim is intended to cover both parts of the computer program necessary for the execution of the aforementioned methods.

Computer program product, comprising program code means stored on a computer readable medium for carrying out the method of anyone of the aforementioned method when said program product is run on a PSM or a user wireless remote control terminal.

### BRIEF DESCRIPTION OF THE DRAWINGS

FIG. 1 depicts a pluggable server module according to one embodiment of the present invention;

FIG. 2a and FIG. 2b depict two different embodiments to store device specific user interfaces in the device or in the pluggable server.

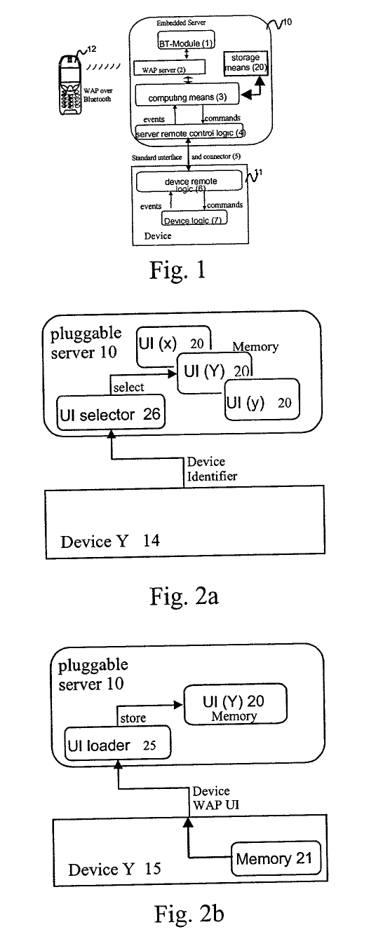

FIG. 1 shows one possible implementation using WAP and Bluetooth. Other implementations may use other media like HomeRF or Wireless Local Area Networks (LAN) or another Hypertext server than WAP (XML, HTML, etc.).

A device 11 comprises a conventional device logic 7 for conventional inputs. The device logic 7 is connected to a device remote control logic 6 adapting the standard interface and connector (SLAD) 5 to the device logic. In the SIAD 5 a pluggable server module (PSM) 10 is inserted. The SIAD provides an electrical (or optical) and mechanical contact between the PSM and the device. In the PSM the server remote control 4 adapts the standard interface connector 5 to the computing means 3 electrically (optically) and logically. A WAP server 2 is connected to or executed by the computing means 3. Typically, the computing means is a processor, which also runs the WAP server 2. The WAP server 2 is connected to the Bluetooth™ module 1. The Bluetooth™ module 1 can contact a user interface device 12 via radio frequency. So the user interface device 12 is indirectly connected to the device logic 7 and is therefore able to remotely control the device. It is also possible to use the connection in the other direction to request events or status information from the device 11.

The device specific user interface (DSUI) is stored inside the WAP server 2 in WML and WML script format. The DSUI is, e.g., a WAP page containing the options selectable in the device. The user interface is a software element used to display a human readable presentation of the commands available. Moreover it displays user relevant status information of the connected device.

The invention only requires a novel standard interface and connector which has to be specified between the server and the device. Standardized in this respect means that the interface works in accordance with a globally or regionally accepted standard or even according to a manufacturer specific standard.

In the simplest case the remotely controlled device comprises a number of switches related to the voltage states in the standardized interface and connector.

FIG. 2a and 2b describe two different possibilities to store the device specific user interfaces (DSUI). One important advantage of the invention is that once a general interface for pluggable servers is defined, any company may manufacture these pluggable server modules (PSM) to be plugged into any other companies appliances, if these appliances support this interface. However, there is still the question how to load the WAP content (say DSUI) into the server which constitutes the appliance's user interface.

FIG. 2a describes the access to device specific user interfaces 20 (DSUI) of a pluggable server module PSM 10. This first method is straightforward. It is assumed that the PSM 10 is pre-configured with a number of DSUIs 20, being stored as, e.g., WML pages. The device 14 identifies itself to the PSM 10 (either on startup or on devices request) and the PSM 10 selects the corresponding DSUI 20 from a number of available DSUIs 20 with the UI selector 26. The DSUIs 20 can be updated, e.g., by plugging the PSM 10 in a corresponding slot of a personal computer (PC) (not shown) and downloading the DSUI according to manufacturer information like serial number and the like.

Another simple implementation for this update method would be to connect the pluggable server 10 through Bluetooth™ or serial line to a PC which in turn is connected to the Internet. The DSUI (Device Specific User Interface) file is downloaded from the manufacturer Web site to the PC and then stored into the pluggable server module 10.

A possible way to upload the UI (dealers and end users) would be to connect the pluggable server module 10 though its standardized interface and connector to, e.g., a PC. Alternatively, manufacturers may preload the WAP server with DSUIs for certain devices

Another, still more convenient, implementation would be that the PSM 10 itself creates a dial up networking connection to the DSUI server, e.g. through a Bluetooth™ phone or also by accessing a Bluetooth access point in the vicinity which offers easy access to a network which can provide connection to the DSUI server. Either the PSM 10 directly dials up the manufacturer or it first connects to an internet service provider. This method is very attractive, since the UI does not have to be pre-stored in the PSM 10 of the DSUI and the DSUI download just requires the Bluetooth™ phone itself. Moreover, this method could be used to update the user interface regularly or download informative pages onto the PSM 10 (e.g. advertising a new model of the device).

FIG. 2b describes an other method to access device specific user interfaces (DSUI) 20 of a pluggable server module PSM 10. This method assumes that the device 15 itself simply stores its WAP DSUI in memory 21 (e.g. ROM) and stores it into the PSM 10 by means of the UI loader 25 once this is connected. This has the advantage over the previous method, that the total cost is smaller, since only the required DSUI has to be stored in the memory 21. However, it makes the device 15 itself slightly more expensive. The second advantage of the method described in FIG. 2b is, that it is a ‘plug and play’ solution, wherein the PSM 10 can be used for an unlimited number of devices, without the need for special memory requirement to the PSM 10. The main advantage is that the DSUI stays in the device 15, and is accessible, even when the respective device is not manufactured for ages. The second advantage is that a server as described in FIG. 2a can be used with the device too, the fact that information is accessible does not mean it has to be accessed, and the stored information provides a bit of redundancy.

The server's connector will be plugged into the device. Once the user interacts with the UI, certain scripts may be triggered, which interact with the remote control logic 4. For example, pins on the connector are set to high or low, or datagrams are sent over the connector. These signals are translated in the device's remote control logic 6 into commands which control the device in the desired manner.

Besides the DSUI 20 the pluggable server module 10 might download and store device specific user manuals which the PSM 10 can provide upon user request if the user is not very familiar with the device 11, 14, 15 which is to be controlled. Furthermore e.g. service contacts can be stored and provided to the user if problems with the device appear which can not be sorted out by accessing the user manual. If the remote control terminal is a mobile telephone the service contact information might be used to establish an internet connection to the device manufacturer or initiate a phone call to a call center for this device automatically.

The pluggable server module can further be connected by a bus system to several devices which shall be controlled. For this purpose the pluggable server module communicates to the controlled devices using the individual devices addresses. The pluggable server might have different dedicated user interfaces and command sets stored for each device to enable to control each device separately and provide a user interface for the remote control terminal.

Script interpreters require additional memory and execution power, but native scripts are not portable, dangerous in execution, and are almost impossible to download in runtime. In this invention we propose a method of circumventing the problems of user defined scripting by providing a method for general-purpose remote method invocation by means of “predefined scripts”. This method circumvents the need for user-defined server-side scripts for a wide range of applications. These predefined scripts are implemented by the manufacturer, typically in native code. The idea is to trigger and parameterize a server side function to be invoked by means of the parameters of a content request to a predefined, server side script. Moreover, the idea includes a method (described below) to determine the return pages of this remote method invocation entirely by user defined content.

A first approach would be, to define one server side script for each method available in the server.

One possible problem with such predefined scripts (e.g. URL://connector_pin1_UP.cgi) is that the scripts would return pages which are not defined by the device specific user interface, which is downloaded. But there are several means to later-on customize the pages returned by these predefined URLs by means of the downloaded contents.

One possibility is to map every predefined URL (e.g. URL://connector_pin1_UP) with another URL (e.g. URL://connector_pin1_UP_user_content) that is displayed at the end of the script execution. The content of the second URL is user defined. However, this response cannot be parameterized by the result of the remote command execution.

A preferred solution being part of the present invention is based on two ideas:

the desired return URL is passed as a parameter to the predefined script

the PSM invisibly returns the execution result by means of variables values (e.g. WML browser variables) which can then be used to parameterize the content displayed, thus reflecting the command results.”)

One example implementation for WAP:

The content request references a CGI-script and passes the parameters for the remote command in the query string or the post-fields. One of these parameters is the user defined URL to be loaded after the execution. This page should later dynamically display the execution results.

The command is remotely executed and the command result is made available to the PSM

The PSM first creates an invisible WML page. This page does two things in the terminal: Firstly, it simply sets one or more Browser variables, reflecting the execution result. Second, it subsequently and automatically loads the user defined URL, passed in the previous request (by requesting it from the PSM).

The user defined URL may reference a WML script, that reads the local browser variables in order to dynamically display content reflecting the execution result.

Alternatively, the invisible page could always reload the previous page, which detects that it has been recalled after execution and dynamically branches to display the command result.

### EXAMPLE

Lets say a person wants to leave a house using her mobile phone and the PSM to control the alarm system and close the door. Port 1 of the PSM shall activate the alarm system (set to high) and Port 3 shall close the door (set to low). This would be achieved by the following WML code snippet:

:
<anchor>
LEAVE HOUSE
<go method=“post” href = “call.cgi”>

<postfield name = “PW1” value = “1” />
<postfield name = “PW3” value = “0” />
<postfield name = “UC“ value = “mycontent.wmlc” />

</go>
</anchor>
:

Lets say, the parameters obey a special syntax: General purpose Ports are identified with a “P” and if these are to be Written, a “W” is appended. The number of the respective port is appended after the operation, so that we obtain PW1 or PW3, respectively. The values “1” and “0” simply mean high and low, respectively. The parameter UC specifies the User defined Content to be displayed once the script returns. Using such syntax, remote operation can be invoked and parameterized.

Let's assume, everything went ok. The WML page created by the CGI script reads like this:

<?xml version=“1.0”?>
<!DOCTYPE wml PUBLIC “-//WAPFORUM//DTD WML 1.1//EN”
“http://www.wapforum.org/DTD/wml_1.1.xml”>
<wml>

<card id=“main” title=“Variables”>

<onevent type=“onenterbackward”>

<prev/>

</onevent>

<onevent type=“onenterforward”>

<go href=““mycontent.wmlc””>

<setvar name=“PT1E” value=“0”/>
<setvar name=“PT1E” value=“0”/>

</go>

</onevent>

</card>

</wml>

This WML page does nothing but create the browser variables PT1E and PT3E and set their value. The “E” stands for “Error”. Since we assume that the server operations succeeded, both return code values PT1E and PT3E are set to “0” (=success). Please note, that the content has to be translated to WMLC before transmission to the WML browser.

The user page mycontent.wmlc can now read the browser variables PW1E and PW3E and display a message

have a nice day

in case everything went ok (both PW1 and PW3 equal “0”), or alert the user to look after the house:

your door is closed, but you'd better look after your alarm system.

Most important: Even though the script call.cgi (Common Gateway Interface) is not specific to any application, still the user interface can be defined by the user.

Alternatively, the invisible page could always reload the previous page, which detects that it has been recalled after execution and dynamically branches to display the command result.

Finally the advantages of the pluggable server module are:

General purpose pluggable server can be manufactured in large volumes and can thus be cheaper than many device specific, embedded implementations.

The feature is only paid for by those who need it.

If manufacturers open their remote control interface logic (as accesses by the embedded server), any company can create the WAP and HTML user interface. This is to say, there will be separate markets and thus competition for user interface software (i.e. content), pluggable servers and devices themselves.

The DSUI can be updated or exchanged easily.

1. Pluggable server module (10), for remote controlling of a device (11), comprising a wireless transceiver (1), a computing means (3), a server remote control logic (4), a standardized interface and a connector (5) for connecting to said device (11), wherein said wireless transceiver (1) is connected to said computing means (3), said computing means (3) is connected to said server remote control logic (4), and said server remote control logic (4) is connected to said standardized interface and said connector (5).

2. Pluggable server module according to claim 1, further comprising a wireless protocol stack server (2) connected between said wireless transceiver (1) and said computing means (3).

3. Pluggable server module according to claim 1 or 2, further comprising a storage means (20) connected to said computing means (3) for storing user interface data.

4. Device, comprising a logic element (7), wherein the device is characterized by a standardized interface and connector (5) for connecting to a pluggable server, and a control logic (6), wherein said standardized interface and said connector (5) are connected to said control logic (6), and said device control logic (6) is connected to said logic element (7).

5. Device according to claim 4, further comprising storage means connected to said device remote control logic (6) for storing user interface data.

6. Method for remote controlling of a device (11) by a wireless remote control terminal (12) via a wireless link, a pluggable server (10) connected to said device via a standardized interface and a connector (5), comprising the steps of:
transferring a content request by wireless protocol stack via said wireless link from said wireless remote control terminal (12) to said pluggable server (10);
invoking the desired remote command in device (11) by using a communication protocol on the standardized interface and connector (5), the remote command being triggered, specified and parameterized by said content request to the pluggable server;
executing said command in said device (11);
communicating the result of the remote command execution in said device (11) from said device (11) to said pluggable server (10);
creating a corresponding response page in said pluggable server (10); and
transmitting and displaying said corresponding response page on the remote control terminal (12).

7. Method according to claim 6, further comprising the steps of:
transferring user interface content and/or auxiliary content interface by a wireless protocol stack from said pluggable server (10) to said wireless remote control terminal (12), that may contain among others a set of commands for controlling said device (11) or said pluggable server (10) via said wireless link;
displaying said contents on a display in said wireless remote control terminal (12).

8. Method according to claim 7, further comprising the steps of:
selecting one of the commands in said terminal (12), by a user input; and
generating a contents request in said terminal (12) according to said selection.

9. Method for transferring user interface data for preparing the remote controlling of a device by means of a pluggable server module, from said device to said pluggable server module, if comprising the steps of:
detecting a pluggable server module connected to a standardized interface and a connector of said device;
retrieving said user interface data from a storage means of said device; and
transferring said user interface data to said pluggable server module via said standardized interface and said connector.

10. Method for retrieving user interface data for preparing the remote controlling of a device by means of a pluggable server module, comprising the steps of:
requesting device identifying information from said device, containing at least device and manufacturer related information;
receiving and storing said device identifying information in said pluggable server module;
transferring said device identifying information to a network access point which may be the remote control terminal (12) itself,
transferring said device identifying information from said Network Access Point to a communication network;
receiving said user interface data by response from said communication network; and
storing said user interface data in said pluggable server module.

11. Method according to claim 10, wherein the transfer of said device identifying information from said remote control terminal to said communication network is executed by:
transferring said device identifying information first to an internet access point via a telephone network, and then
transferring said device identifying information from said internet access point to said communication network via Internet.

12. Computer program for remote controlling of a device (11) by a wireless remote control terminal (12) via a low power radio link, a pluggable server (10), comprising program code means for carrying out the steps of anyone of claims 6 to 11 when said program is run on an installation bus gateway (10) or a user interface device (20).

13. Computer program product, comprising program code means stored on a computer readable medium for carrying out the method of anyone of claims 6 to 11 when said program product is run on an installation bus gateway (20) or a user interface device (20).
